(19) United States
(12) Patent Application Publication
(10) Pub. No.: US 2011/0143671 A1
(43) Pub. Date: Jun. 16, 2011

(54) INPUT DEVICE WITH MULTI-OBJECT SWITCH TRANSMISSION

(75) Inventor: Yu-Chun HSIEH, New Taipei City (TW)

(73) Assignee: ZIPPY TECHNOLOGY CORP., New Taipei City (TW)

(21) Appl. No.: 13/033,978

(22) Filed: Feb. 24, 2011

Related U.S. Application Data
(63) Continuation-in-part of application No. 12/717,479, filed on Mar. 4, 2010.

(30) Foreign Application Priority Data
Mar. 6, 2009 (TW) 098107207

(51) Int. Cl. H04B 7/00

(52) U.S. Cl. 455/41.2

(57) ABSTRACT

An input device with multi-object switch transmission aims to establish a data transmission link between an input device and at least one information processing system. The input device contains a Bluetooth transmission device, a memory unit, a circuit unit and a micro control unit. The memory unit presets a plurality of protocol data fields. The Bluetooth transmission device gets multiple sets of Bluetooth communication protocol codes from multiple linkable information processing systems. The micro control unit saves each set of Bluetooth communication protocol code corresponding to each information processing system in each protocol data field of the memory unit. The circuit unit is triggered by a user to output a corresponding selection signal. The selection signal triggers the micro control unit to access the Bluetooth communication protocol code in a selected protocol data field from the memory unit to link the Bluetooth transmission device to one information processing system.

### FIELD OF THE INVENTION

The present invention relates to an input device with multi-object switch transmission and particularly to an input device to transmit input messages to multiple information processing systems through a wireless link protocol.

### BACKGROUND OF THE INVENTION

Keyboard has become one of the necessary and basic output devices since computers have been developed in early stages. Although personal computers have gone through a great deal of progress these years, the keyboard still maintains substantially the same basic style. With improvements in material and structure, the size and weight of the keyboard have been reduced significantly in recent years. Composite keyboards that can be folded and expanded even have been developed, and flexible keyboards that can be rolled and bent also are available. Many types of keyboards are being designed as portable computer accessories to facilitate carrying. However, there is still one constraint existed today that greatly limits the usability of the keyboard, i.e. linkage between the conventional keyboard and a computer system has to rely on a signal cable. The signal cable usually has a limited length that restricts distance and environment during use. To overcome this constraint, the approach wireless technology adopted on the keyboard has been proposed in prior art. For instance, R.O.C. patent No. 510537 entitled “Wireless keyboard” discloses a technique to transmit signals to a computer host through infrared ray or radio frequency (RF). While the keyboard adopted the wireless technique (mainly the infrared ray) to transmit signals has mostly overcome the problem of the limited length of the signal cable, the infrared ray also has its disadvantages of limited linkage distance and angle, and easily being blocked by obstacles. Hence signal transmission is easily interrupted and results in errors.

In addition to the need of constant improvement in signal transmission, the application scope of the conventional keyboard also is too narrow. In the past, the conventional keyboard merely focuses on being applied to computer systems. Before USB interface being widely used, the connection interface (such as PS2 connection terminal) of the keyboard can only be linked to a computer system. But users often have to input data to information products other than computers. For instance, R.O.C. patent No. 532523 entitled “An infrared keyboard with a PDA externally connected” adopts a technique in which a back rack is provided on a keyboard to function as a PDA holder. The back rack also has an infrared emitter. When a PDA is held on the back rack, transmission between the infrared emitter and the PDA can be maintained in a steady quality. Thus messages can be input from the keyboard to the PDA, and input speed is much higher than directly entering data on the PDA.

In recent years, Bluetooth technology has been introduced to the keyboard. For instance, R.O.C. patent No. M341266 entitled “Keys and keyboard” discloses a technique that uses a conductive sheet to form a portion of an antenna. The conductive sheet is bonded to or clamped under a key cap of a key, so that the key includes part of the antenna. It not only provides Bluetooth transmission function, but also saves space.

Although the keyboard equipped with Bluetooth function is superior to infrared transmission, the Bluetooth-enabled keyboard is mainly limited to wireless transmission between the keyboard and a single device at present. The technique of link selection and switch among multiple devices within the Bluetooth transmission range is not yet well adopted. There is still room for improvement on usability in terms of application scope of information products.

### SUMMARY OF THE INVENTION

In view of the aforesaid conventional techniques that still leave a lot to be desired, the present invention aims to provide an input device linked to multiple information processing systems to switch linking objects according to user's desire.

The present invention provides an input device with multi-object switch transmission to establish a data transmission link between an input device and at least one information processing system. The input device contains a Bluetooth transmission device and also includes a memory unit, a circuit unit and a micro control unit. The memory unit presets a plurality of protocol data fields. The Bluetooth transmission device gets multiple sets of Bluetooth communication protocol codes from multiple linkable information processing systems. The micro control unit saves each set of Bluetooth communication protocol code corresponding to each information processing system in a respective protocol data field of the memory unit. The circuit unit can be triggered by a user to output a corresponding selection signal. The selection signal triggers the micro control unit to read the Bluetooth communication protocol code from a specific protocol data field in the memory unit for the Bluetooth transmission device to establish a link to one of the information processing systems.

By means of the technique set forth above, the input device can store multiple Bluetooth communication protocol codes simultaneously that are required to establish data transmission link with multiple information processing systems. User can select any one set of Bluetooth communication protocol code through a key or switch to establish a data transmission link with the selected information processing system. The Bluetooth communication protocol code can be a device identification code (Bd_address), a device authorization code (link key) or a combination of the device identification code (Bd_address) and device authorization code (link key).

In short, a user can use the input device of the invention to enter information to different information processing systems in varying conditions to facilitate switching and also maintain the advantage of wireless transmission without cable constraint.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of the invention.

FIG. 2 is a circuit block diagram of the input device.

FIG. 3 is a schematic view showing data access according to the invention.

FIG. 4 is a schematic view of a first embodiment of the invention.

FIG. 5 is a schematic view of a second embodiment of the invention.

FIG. 6 is a schematic view of a third embodiment of the invention.

FIG. 7 is a schematic view of a fourth embodiment of the invention.

FIG. 8 is a schematic view of a fifth embodiment of the invention.

### DETAILED DESCRIPTION OF THE PREFERRED EMBODIMENTS

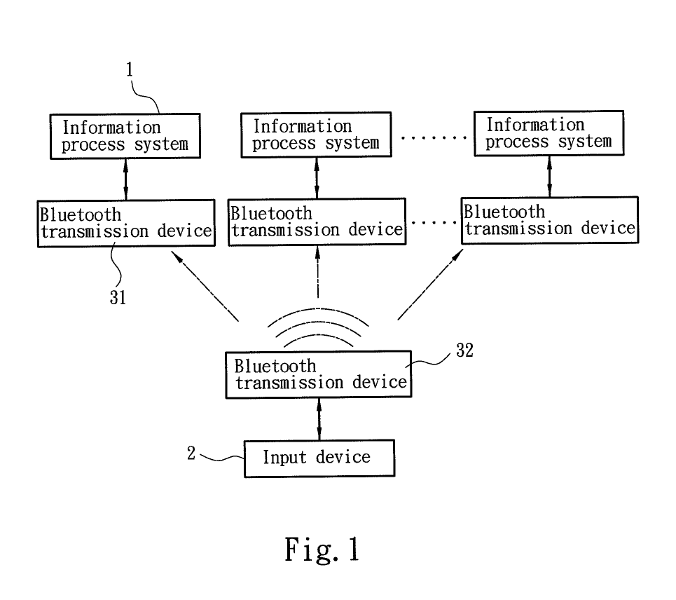

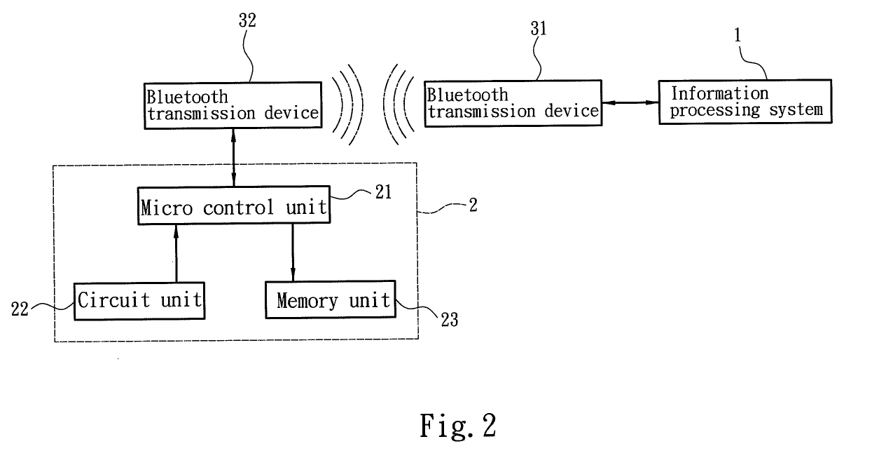

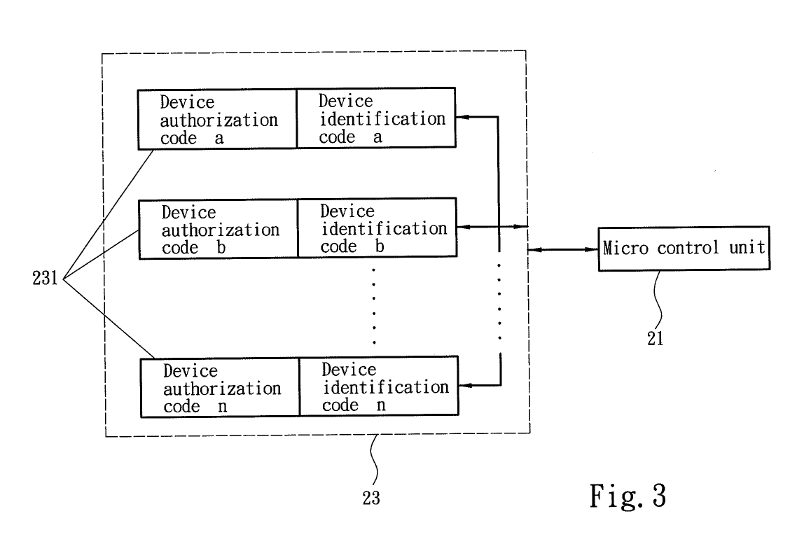

The present invention aims to provide an input device with multi-object switch transmission to establish a data transmission link between an input device 2 and at least one information processing system 1 through wireless transmission. Referring to FIGS. 1 and 2, the input device 2 contains a second Bluetooth transmission device 32 to establish a data transmission link with the information processing system 1 having a first Bluetooth transmission device 31. The first and second Bluetooth transmission devices 31 and 32 can be externally connected to or built in the information processing system 1 or input device 2. The input device 2 includes a micro control unit 21, a circuit unit 22 and a memory unit 23. The memory unit 23 presets a plurality of protocol data fields 231 (also referring to FIG. 3). When the second Bluetooth transmission device 32 is controlled by a user to detect the linkable information processing system 1 within a range, it gets the Bluetooth communication protocol code of the information processing system 1 to establish an initial link. The micro control unit 21 saves each set of the Bluetooth communication protocol code corresponding to each information processing system 1 in the protocol data field 231 of the memory unit 23.

The circuit unit 22 is controlled by the user to generate a selection signal selected by the user. The selection signal is sent to the micro control unit 21. Different selection signals are corresponding to different protocol data fields 231. The micro control unit 21 receives one selection signal and accesses the corresponding protocol data field 231 from the memory unit 23, and then sends the accessed Bluetooth communication protocol code to the second Bluetooth transmission device 32 to establish a data transmission link with a corresponding information processing system 1. The Bluetooth communication protocol code can be a device identification code (Bd_address), a device authorization code (link key) or a combination of the device identification code (Bd_address) and device authorization code (link key). FIG. 3 depicts an embodiment in which the Bluetooth communication protocol code is a combination of the device identification code (Bd_address) and device authorization code (link key) to serve as an example. In FIG. 3, the memory unit 23 contains multiple preset protocol data fields 231. Each protocol data field 231 stores one set of the Bluetooth communication protocol code which is a combination of the device identification code (Bd_address) and the device authorization code (link key).

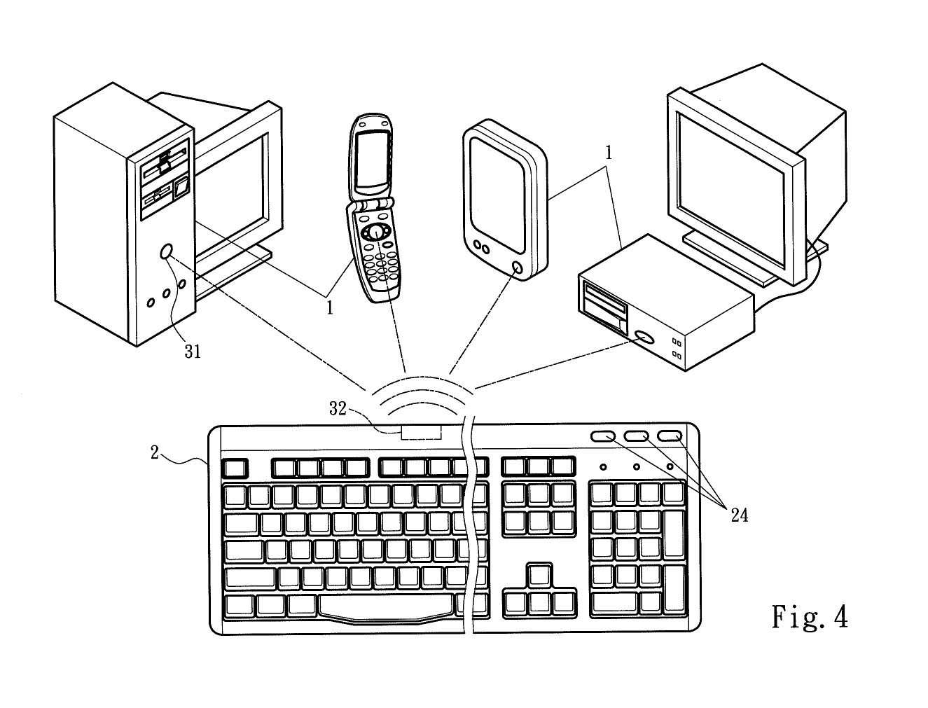

The aforesaid circuit structure can be implemented in a wide variety of embodiments. FIG. 4 illustrates a first embodiment in which the input device 2 is a keyboard including a plurality of keys and a plurality of device switch keys 24 to trigger the circuit unit 22 to output a character signal to the information processing system 1. Different device switch keys 24 can trigger the circuit unit 22 to generate selection signals corresponding to different protocol data fields 231.

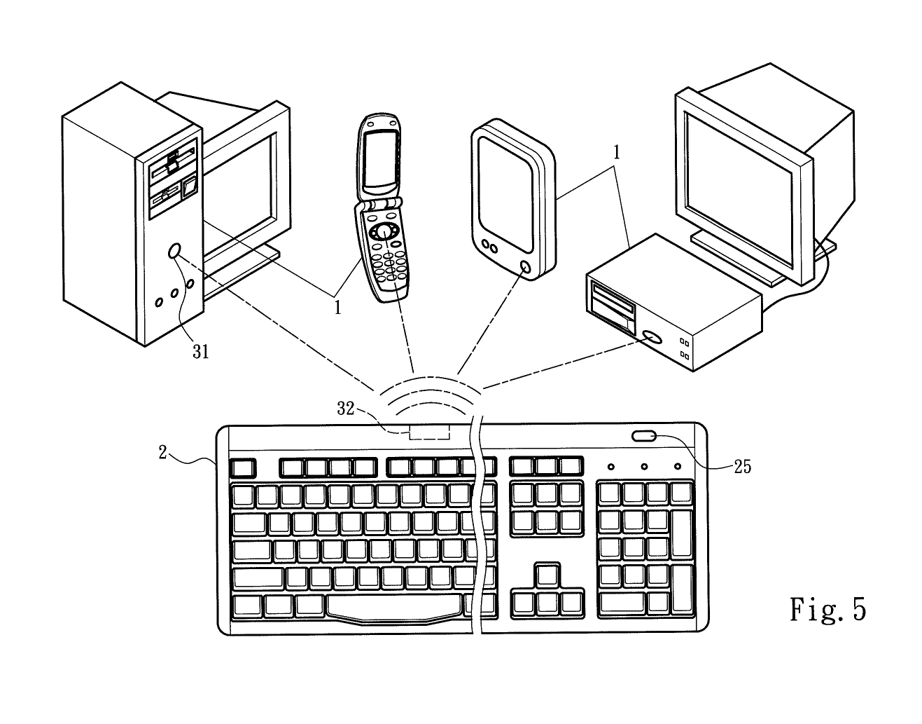

FIG. 5 shows a second embodiment in which the keyboard contains keys to form multiple key combinations depressed to trigger the circuit unit 22 to output different selection signals corresponding to varying protocol data fields 231. Each key combination includes at least two keys. In the embodiment shown in FIG. 5, a switch function key 25 is provided. The switch function key 25 and at least one key are depressed to form a specific key combination to generate a corresponding device selection code. For example, the user depresses the switch function key 25 first and then presses keys “F1” to “F4” to select one of four information processing systems 1 to establish a data transmission link.

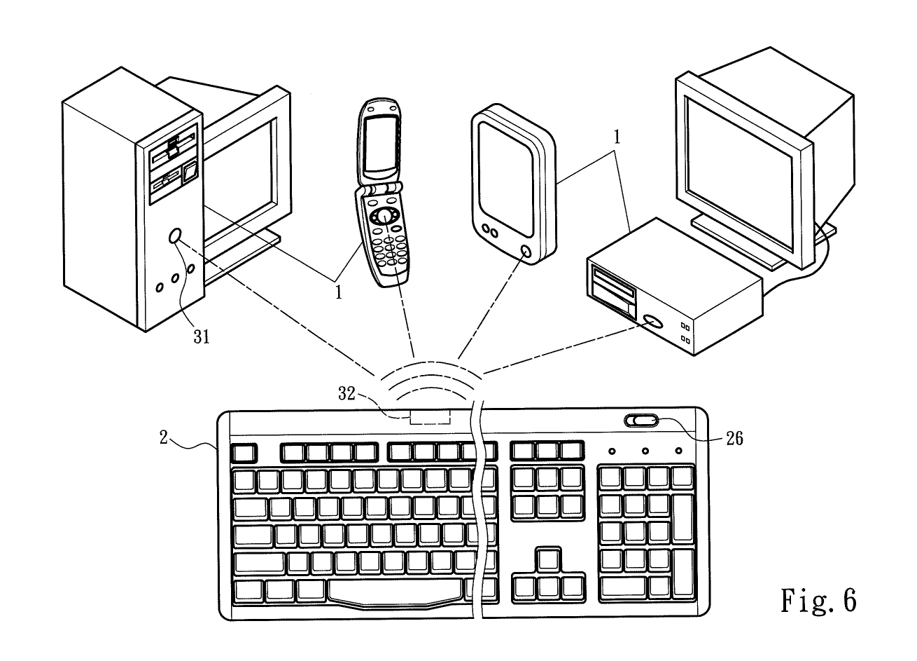

FIG. 6 illustrates a third embodiment in which the keyboard includes a multi-stage switch 26 which has multiple switch selection positions to trigger the circuit unit 22 to generate different selection signals. As shown in the drawings, the information processing system 1 can be a computer, a mobile phone, a PDA (Personal Digital Assistant), or a TV game machine. The computer can also be a portable notebook computer.

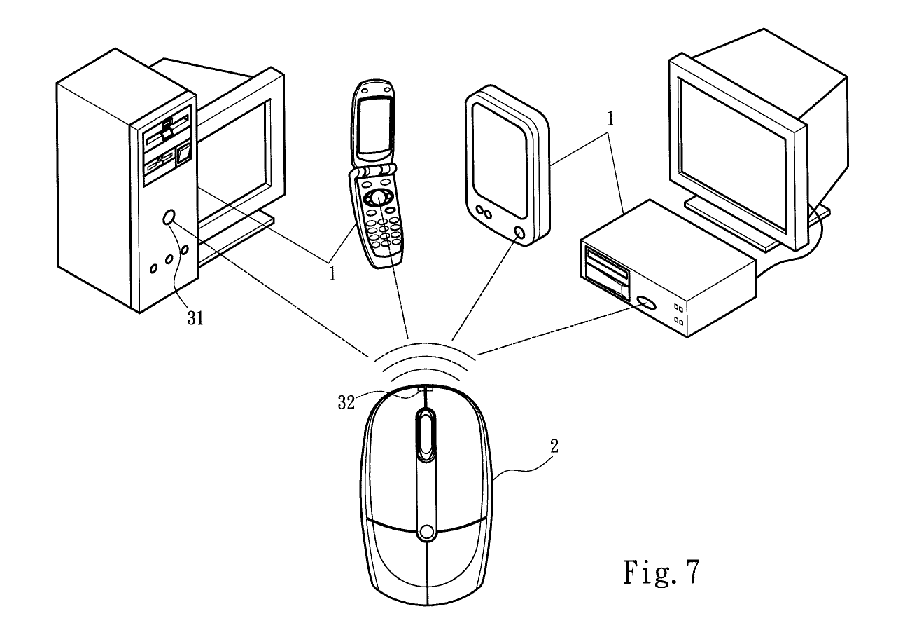

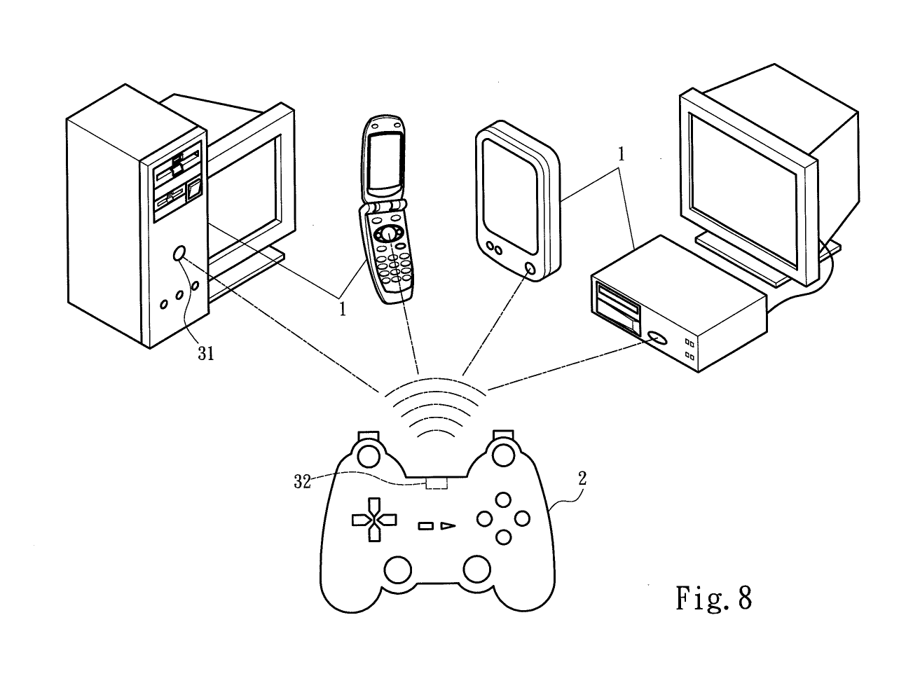

FIG. 7 shows a fourth embodiment in which the input device 2 is a mouse, and FIG. 8 illustrates a fifth embodiment in which the input device 2 is a game controller. The mouse or game controller can include the aforesaid device switch key, multiple key combinations or multi-stage switch as a switching control mechanism. The technique provided by the invention can be easily adopted by those skilled in the art, thus other alternative embodiments based on the invention shall be included in the scope of the invention. Through the selection mechanisms previously discussed, the circuit unit 22 can be triggered to generate varying selection signals by operating the mouse or game controller to drive the micro control unit 21 to access the Bluetooth communication protocol code in the selected protocol data field 231 from the memory unit 23 to establish a transmission link with a corresponding information processing system 1. Therefore, a handy switch function can be achieved and the advantage of wireless transmission without cable constraint can be also maintained.

While the invention has been described by means of specific embodiments, they are not the limitations of the invention. The corresponding access relationship between the Bluetooth communication protocol code and selection signal can be carried out in different fashions through various software or program languages, such as address jump and the like. Since the way of data storage and access are not the focused features of the invention and the corresponding access methods are known to those skilled in computer programming techniques, numerous modifications and variations could be made thereto by those skilled in the art without departing from the scope and spirit of the invention set forth in the claims.

In summation of the above description, the present invention provides a significant improvement over the conventional techniques and complies with the patent application requirements, and is submitted for review and granting of the commensurate patent rights.

What is claimed is:

1. An input device with multi-object switch transmission, comprising:
a Bluetooth transmission device to get multiple sets of Bluetooth communication protocol codes from a plurality of linkable information processing systems;
a memory unit including a plurality of preset protocol data fields;
a micro control unit electrically connected to the Bluetooth transmission device and the memory unit to save each set of Bluetooth communication protocol code corresponding to each information processing system in each protocol data field of the memory unit; and
a circuit unit triggered by a user to output a corresponding selection signal to trigger the micro control unit to access the Bluetooth communication protocol code in a selected protocol data field from the memory unit to link the Bluetooth transmission device to one of the information processing systems.

2. The input device of claim 1 further including a plurality of keys and a plurality of device switch keys to trigger the circuit unit to output a character signal to the information processing system, different device switch keys triggering the circuit unit to generate the selection signals corresponding to varying protocol data fields.

3. The input device of claim 1 further including a plurality of keys to trigger the circuit unit to output a character signal to the information processing system, the keys including a plurality of key combinations depressed to trigger the circuit unit to output varying selection signals corresponding to varying protocol data fields, each key combination including at least two keys.

4. The input device of claim 1 further including a plurality of keys and a multi-stage switch to trigger the circuit unit to output a character signal to the information processing system, the multi-stage switch including multiple switch selection positions to trigger the circuit unit to generate varying selection signals corresponding to varying protocol data fields.

5. The input device of claim 1, wherein the information processing system is selectively a computer, a mobile phone, a personal digital assistant (PDA) or a TV game machine.

6. The input device of claim 1, wherein the Bluetooth communication protocol code is selectively a device identification code (Bd_address), a device authorization code (link key) or a combination of the device identification code (Bd_address) and the device authorization code (link key).
